(19) United States
(12) Patent Application Publication
(10) Pub. No.: US 2002/0037976 A1
(43) Pub. Date: Mar. 28, 2002

(54) Photo curable adhesive composition

(76) Inventors: Hitomi Nomiyama, Ibaraki (JP); Yuichi Takehana, Tsukuba (JP); Takashi Ukachi, Ushiku (JP); Takayoshi Tanabe, Mieken (JP)

Correspondence Address: PILLSBURY WINTHROP LLP, 1600 TYSONS BOULEVARD, MCLEAN, VA, 22102, US

(21) Appl. No.: 09/902,495

(22) Filed: Jul. 11, 2001

Related U.S. Application Data
(63) Continuation of application No. PCT/NL00/00014, filed on Jan. 11, 2000.

(30) Foreign Application Priority Data
Jan. 13, 1999 (JP) 006012/1999
Jan. 13, 1999 (JP) H11-006012

(51) Int. Cl. C08G 75/00

(52) U.S. Cl. 525/535

(57) ABSTRACT

To provide a photo curable resin composition comprising (A) a cationically polymerizable organic compound, (B) a cationic photopolymerization initiator, (C) a polyol having two or more hydroxyl groups in the molecule, and (D) an organotin compound.

Since the photo curable resin composition of the present invention has excellent moisture-heat resistance, the resin composition is very useful as an adhesive used in the manufacture of optical disks compared to conventional adhesives.

### DETAILED DESCRIPTION OF THE INVENTION

1. Field of the Invention

The present invention relates to a photo curable adhesive composition. More particularly, the present invention relates to a composition useful as an adhesive used in the manufacture of optical disks and the like.

2. Prior Art

In recent years, higher grade information such as texts, voice, and images has brought about the demand for large-capacity recording media and development of high-density recording media has progressed. An optical disk referred to as a DVD (digital video disk) is one of such high-density recording media. The DVD is almost the same size as a conventional CD (compact disk) but can store much more information than the CD. At present, the DVD is mainly manufactured by a lamination method which comprises forming an information recording layer by depositing a metal onto at least one sheet of a plastic substrate using a sputtering method, and causing the recording layers of each medium or the recording layer and the substrate to adhere using an adhesive.

As this adhesive, hot-melt type, adhesive-sheet type, and radically polymerizable UV-curable type adhesives have been conventionally used. However, the hot-melt adhesive exhibits low productivity and insufficient heat resistance, and the adhesive sheet-type adhesive exhibits insufficient heat resistance and inferior durability. The radically polymerizable UV-curable adhesive excels in productivity, heat resistance, and durability, but is incapable of causing the recording layers which do not transmit ultraviolet rays to adhere. To overcome this problem, for example, Japanese Patent Application Laid-open No. 126577/1995 disclosed a process for manufacturing an optical disk which comprises forming layers of a cationically polymerizable UV-curable liquid adhesive on the lamination surfaces of two disk substrates, irradiating an energy ray to these layers, and laminating the disk substrates to join and solidify the substrates under pressure. Since the recording layers which do not transmit ultraviolet rays will adhere when using such a cationically polymerizable UV-curable adhesive layer, use of such an adhesive has been examined as a technology for achieving high productivity as well as superior heat resistance.

However, when the cationically polymerizable UV-curable adhesive is used, the recording layers have a tendency to corrode under hot and humid conditions, thereby resulting in inferior durability.

### PROBLEMS TO BE SOLVED BY THE INVENTION

Accordingly, to overcome the above problems of the prior art, an object of the present invention is to provide a cationic photo curable adhesive composition capable of producing a cured product exhibiting excellent adhesion under hot and humid conditions and which does exhibits improved resistance to corrosion of metals of the recording layer.

### MEANS FOR THE SOLUTION OF THE PROBLEMS

As a result of extensive studies, the inventors have found that the above problems can be solved by the photo curable adhesive composition comprising (A) a cationically polymerizable organic compound, (B) a cationic photopolymerization initiator, (C) a polyol having two or more hydroxyl groups in the molecule, and (D) an organotin compound.

### PREFERRED EMBODIMENT OF THE INVENTION

The cationically polymerizable organic compound (A) of the photo curable adhesive composition of the present invention (hereinafter called “component (A)”) is an organic compound which polymerizes or crosslinks in the presence of a cationic photopolymerization initiator upon exposure to radiation. Preferably component A consists at least in part of a compound having 2 or more cationic polymerizable groups in order to achieve fast-cure speed. The molecular weight of the compounds constituting component A is not particularly crucial; the molecular weight preferably is higher than 50, more preferably higher than 100. Generally the molecular weight will be lower than 10,000, preferably lower than 2000. The compounds constituting component A are preferably so chosen as to achieve a viscosity of the adhesive composition of about 50 to about 30,000 mPas at 25° C. as measured with a Physica MC10 viscometer in a conventional Z3 system setup.

Examples of the component (A) include cyclic ether compounds such as an epoxy compound, oxetane compound, and oxolane compound; cyclic thioether compounds such as a thiirane compound and thiethane compound; cyclic acetal compounds; cyclic lactone compounds; vinyl ether compounds; spiroorthoester compounds which are a reaction product of an epoxy compound and a lactone; ethylenically unsaturated compounds; and the like.

Among the cyclic ether compounds which can be used as the component (A), examples of epoxy compounds include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolak resin, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexanecarboxylate, 2-(3,4-epoxycyclohexyl-5,5-spiro-3,4-epoxy)cyclohexane-meta-dioxane, bis(3,4-epoxycyclohexylmethyl)adipate, vinylcyclohexeneoxide, 4-vinylepoxycyclohexane, bis(3,4-epoxy-6-methylcyclohexylmethyl)adipate, 3,4-epoxy-6-methylcyclohexyl-3′,4′-epoxy-6′-methylcyclohexanecarboxylate, methylene-bis(3,4-epoxycyclohexane), dicyclopentadienediepoxide, di(3,4-epoxycyclohexylmethyl) ether of ethylene glycol, ethylenebis(3,4-epoxycyclohexanecarboxylate), epoxyhexahydrodioctylphthalate, di-2-ethylhexyl-epoxyhexahydrophthalate, 1,4-butanediol diglycidyl ether, 1,6-hexanediol diglycidyl ether, glycerol triglycidyl ether, trimethylolpropane triglycidyl ether, polyethylene glycol diglycidyl ether, and polypropylene glycol diglycidyl ether; polydiglycidyl ethers of a polyether polyol obtained by the addition of one or more alkylene oxides to an aliphatic polyhydric alcohol such as ethylene glycol, propylene glycol, and glycerol; diglycidyl esters of aliphatic long-chain dibasic acid; monodiglycidyl ethers of an aliphatic higher alcohol; monodiglycidyl ethers of phenol, cresol, butyl phenol, or a polyether alcohol obtained by the addition of an alkylene oxide to these compounds; glycidyl esters of higher fatty acid; epoxidated soybean oil; butyl epoxystearic acid; octyl epoxystearic acid; epoxidated linseed oil; epoxidated polybutadiene; and the like. As examples of other cyclic ether compounds which can be used as the component (A), oxetane compounds such as trimethylene oxide, 3,3-dimethyloxetane, 3,3-dichloromethyloxetane, 3-ethyl-3-phenoxymethyloxetane, and bis(3-ethyl-3-methyloxy)butane and oxolane compounds such as tetrahydrofuran and 3-dimethyltetrahydrofuran can be given.

Examples of cyclic thioether compounds which can be used as the component (A) include thiirane compounds such as ethylene sulfide, 1,2-propylene-sulfide, thioepichlorohydrin, thiethane compounds such as 3,3-dimethylthiethane, and the like.

Examples of cyclic acetal compounds include trioxane, 1,3-dioxolane, 1,3,6-trioxanecyclooctane, and the like. Examples of cyclic lactone compounds include β-propyolactone, ε-caprolactone, and the like. Examples of vinyl ether compounds include ethylene glycol divinyl ether, triethylene glycol divinyl ether, trimethylolpropane trivinyl ether, and the like.

Examples of ethylenically unsaturated compounds include vinylcyclohexane, isobutylene, polybutadiene, and the like. Of these cationically polymerizable organic compounds, epoxy compounds, in particular, bisphenol A diglycidyl ether, bisphenol F diglycidyl ether, hydrogenated bisphenol A diglycidyl ether, hydrogenated bisphenol F diglycidyl ether, 3,4-epoxycyclohexylmethyl-3′,4′-epoxycyclohexanecarboxylate, bis(3,4-epoxycyclohexylmethyl)adipate, 1,4-butanediol diglycidyl ether, 1,6-hexanediol diglycidyl ether, glycerol triglycidyl ether, trimethylolpropane triglycidyl ether, neopentyl glycol diglycidyl ether, polyethylene glycol diglycidyl ether, and polypropylene glycol diglycidyl ether are preferable.

Examples of commercially available products of these cationically polymerizable organic compounds suitably used as the component (A) include UVR-6100, UVR-6105, UVR-6110, UVR-6128, UVR-6200, UVR-6216 (manufactured by Union Carbide Corp.), Celoxide 2021, Celoxide 2021P, Celoxide 2081, Celoxide 2083, Celoxide 2085, Celoxide 2000, Celoxide 3000, Glycidole, AOEX 24, Cyclomer A200, Cyclomer M100, Epolead GT-300, Epolead GT-301, Epolead GT-302, Epolead GT-400, Epolead 401, Epolead 403 (manufactured by Daicel Chemical Industries, Ltd.), Epicoat 828, Epicoat 812, Epicoat 1 031, Epicoat 872, Epicoat CT508 (manufactured by Yuka-Shell K.K.), KRM-2100, KRM-2110, KRM-2199, KRM-2400, KRM-2410, KRM-2408, KRM-2490, KRM-2200, KRM-2720, KRM-2750 (manufactured by Asahi Denka Kogyo Co., Ltd.), Rapi-Cure DVE-3, CHVE, PEPC (manufactured by ISP), VECTOMER 2010, 2020, 4010, 4020 (manufactured by Allied Signal), and the like.

These cationically polymerizable compounds can be used either individually or in combinations of two or more as the component (A).

The proportion of these cationically polymerizable compounds for the component (A) used in the photo curable resin composition of the present invention is preferably 30-96 wt %, more preferably 40-94 wt %, and particularly preferably 40-90 wt %. The amount of the component (A) to be used is preferably 60-97 parts by weight, more preferably 60-95 parts by weight, and particularly preferably 70-90 parts by weight of the total 100 parts by weight of the components (A) to (C). It is preferred to have at least 50 wt. % of the compounds constituting component (A) to be at least di-functional, more preferably, more than 80 wt. % of the compounds constituting component (A) are 2 or more functional. It is most preferred to use two-functional compounds for component (A).

The cationic photopolymerization initiator (B) used in the photo curable resin composition of the present invention (hereinafter called “component (B)”) generates a substance which initiates the cationic polymerization of the component (A) upon exposure to energy rays such as light. As examples of particularly preferable compounds, an onium salt having a structure shown by the following formula (1) can be given. An onium salt liberates a Lewis acid upon exposure to light.

[R¹ₐR²_{b}R³_{c}R⁴_{d}W]₊ₘ[MXₙ₊ₘ]^{-m} (1)

wherein a cation is an onium ion; W represents S, Se, Te, P, As, Sb, Bi, O, I, Br, Cl, or —N≡N; R¹, R², R³, and R⁴ individually represent organic groups; a, b, c, and d are integers from 0-3, provided that (a+b+c+d) is equal to the valence of W; M represents a metal or metalloid which constitutes a center atom of the halide complex [MXₙ₊ₘ], such as B, P, As, Sb, Fe, Sn, Bi, Al, Ca, In, Ti, Zn, Sc, V, Cr, Mn, Co; X represents a halogen atom such as F, Cl, and Br; m represents a positive charge of a halide complex ion; and n is a valence of M.

Specific examples of the anion (MXₙ₊ₘ) of the above formula (1) include tetrafluoroborate (BF₄⁻), hexafluorophosphate (PF₆⁻), hexafluoroantimonate (SbF₆⁻), hexafluoroarsenate (AsF₆⁻), hexachloroantimonate (SbCl6⁻), and the like.

An onium salt containing an anion shown by the formula [MXₙ(OH)⁻] can be used. An onium salt having other anions such as a perchloric acid ion (ClO₄⁻), trifluoromethanesulfonic acid ion (CF₃SO₃⁻), fluorosulfonic acid ion (FSO₃⁻), toluenesulfonic acid ion, trinitrobenzenesulfonic acid anion, and trinitrotoluenesulfonic acid anion can also be used. Of these onium salts, aromatic onium salts are particularly effective as the component (B). As examples of preferable aromatic onium salts, aromatic halonium salts disclosed in Japanese Patent Application Laid-open No. 151996/1975, No. 158680/1975, and the like, VIA group aromatic onium salts disclosed in Japanese Patent Application Laid-open No. 151997/1975, No. 30899/1977, No. 55420/1981, No. 125105/1980, and the like, VA group aromatic onium salts disclosed in Japanese Patent Application Laid-open No. 158698/1975, oxosulfoxonium salts disclosed in Japanese Patent Applications Laid-open No. 8428/1981, No. 149402/1981, No. 192429/1982, and the like, aromatic diazonium salts disclosed in Japanese Patent Application Laid-open No. 17040/1974 and the like, and thiopyrylium salts disclosed in U.S. Pat. No. 4,139,655 and the like can be given. Iron/allene complex initiators, aluminum complex/photolysis silicon compound initiators, and the like can also be given as examples.

Examples of commercially available products of the cationic photopolymerization initiator suitably used as the component (B) include UVI-6950, UVI-6970, UVI-6974, UVI-6990 (manufactured by Union Carbide Corp.), Adekaoptomer SP-150, SP-151, SP-170, SP-171 (manufactured by Asahi Denka Kogyo Co., Ltd.), Irgacure 261 (manufactured by Ciba Specialty Chemicals Co., Ltd), CI-2481, CI-2624, CI-2639, CI-2064 (manufactured by Nippon Soda Co., Ltd.), CD-1010, CD-1011, CD-1012 (manufactured by Sartomer), DTS-102, DTS-103, NAT-103, NDS-103, TPS-103, MDS-103, MPI-103, BBI-103 (manufactured by Midori Chemical Co., Ltd.), and the like. Of these, use of UVI-6970, UVI-6974, Adekaoptomer SP-170, SP-171, CD-1012, and MPI-103 is particularly preferable because high curing sensitivity can be provided for the resin composition.

These cationic photopolymerization initiators can be used either individually or in combinations of two or more as the component (B).

The proportion of the component (B) used in the photo curable resin composition of the present invention is preferably 0.1-20 wt %, more preferably 0.5-15 wt %, and particularly preferably 1-10 wt %. If the proportion is less than 0.1 wt %, the composition cures insufficiently.

The polyol (C) used in the photo curable resin composition of the present invention (hereinafter called “component (C)”) is blended in order to improve the photocurablity and mechanical characteristics of the resin composition. The component (C) is a compound which has two or more, and preferably 3-6 hydroxyl groups in the molecule. The molecular weight of the compounds constituting component (C) preferably has a molecular weight higher than 50, more preferably higher than 100. The molecular weight of the compounds preferably is lower than 10,000, more preferably lower than 5000. The compounds constituting component (C) preferably are chosen so as to achieve the desired viscosity in combination with the compound(s) constituting component (A), optionally in combination with other components.

As examples of the component (C), polyether polyols, polyester polyols, polycarbonate polyols, polycaprolactone polyols, aliphatic hydrocarbons having two or more hydroxyl groups in the molecule, alicyclic hydrocarbons having two or more hydroxyl groups in the molecule, unsaturated hydrocarbons having two or more hydroxyl groups in the molecule, and the like can be given. These polyols can be used either individually or in combinations of two or more.

Examples of polyether polyols include aliphatic polyether polyols, alicyclic polyether polyols, and aromatic polyether polyols. Examples of aliphatic polyether polyols include polyhydric alcohols such as polyethylene glycol, polypropylene glycol, polytetramethylene glycol, polyhexamethylene glycol, polyheptamethylene glycol, polydecamethylene glycol, pentaerythritol, dipentaerythritol, trimethylolpropane, and alkylene oxide addition polyols such as ethylene oxide addition triol of trimethylolpropane, propylene oxide addition triol of trimethylolpropane, ethylene oxide addition and propylene oxide addition triol of trimethylolpropane, ethylene oxide addition tetraol of pentaerythritol, and ethylene oxide addition hexaol of dipentaerythritol; polyether polyols obtained by the ring-opening polymerization of two or more ion-polymerizable cyclic compounds, and the like. Examples of the above ion-polymerizable cyclic compound include cyclic ethers such as ethylene oxide, propylene oxide, butene-1-oxide, isobutene oxide, 3,3-bischloromethyloxetane, tetrahydrofuran, 2-methyltetrahydrofuran, dioxane, trioxane, tetraoxane, cyclohexene oxide, styrene oxide, epichlorohydrin, glycidyl ether, allyl glycidyl ether, allyl glycidyl carbonate, butadiene monoxide, isoprene monoxide, vinyloxetane, vinyltetrahydrofuran, vinylcyclohexene oxide, phenyl glycidyl ether, butyl glycidyl ether, and glycidyl benzoate. As examples of combination of the above ion-polymerizable cyclic compounds, tetrahydrofuran and ethylene oxide, tetrahydrofuran and propylene oxide, tetrahydrofuran and 2-methyltetrahydrofuran, tetrahydrofuran and 3-methyltetrahydrofuran, ethylene oxide and propylene oxide, butene-l-oxide and ethylene oxide, tetrahydrofuran, butene-1-oxide, and ethylene oxide, and the like can be given.

Polyether polyols obtained by the ring-opening copolymerization of the above ion-polymerizable cyclic compound and cyclic lactone acid such as β-propyolactone and glycolic acid lactide or dimethylcyclopolysiloxanes can also be used.

Examples of alicyclic polyether polyols include alkylene oxide addition diol of hydrogenated bisphenol A, alkylene oxide addition diol of hydrogenated bisphenol F, alkylene oxide addition diol of 1,4-cyclohexanediol, and the like.

Examples of aromatic polyether polyols include alkylene oxide addition diol of bisphenol A, alkylene oxide addition diol of bisphenol F, alkylene oxide addition diol of hydroquinone, alkylene oxide addition diol of naphthohydroquinone, alkylene oxide addition diol of anthrahydroquinone, and the like. Examples of commercially available products of the above aliphatic polyether polyols include PTMG 650, PTMG 1000, PTMG 2000 (manufactured by Mitsubishi Chemical Corp.), PPG 1000, EXCENOL 1020, EXCENOL 2020, EXCENOL3020, EXCENOL4020 (manufactured by Asahi Glass Co., Ltd.), PEG 1000, UNISAFE DC1100, UNISAFE DC1800, UNISAFE DCB1100, UNISAFE DCB1800 (manufactured by Nippon Oil and Fats Co., Ltd.), PPTG 1000, PPTG 2000, PPTG 4000, PTG 400, PTG 650, PTG 2000, PTG3000, PTGL 1000, PTGL 2000 (manufactured by Hodogaya Chemical Co., Ltd.), Z-3001-4, Z-3001-5, PBG 2000, PBG 2000B (manufactured by Daiichi Kogyo Seiyaku Co., Ltd.), TMP30, PNT4 Glycol, EDA P4, EDA P8 (manufactured by Nippon Nyukazai Co., Ltd.), Quadrol (manufactured by Asahi Denka Kogyo K.K.), Tone Polyol 0200, Tone Polyol 0221, Tone Polyol 0301, Tone Polyol 0310, Tone Polyol 2201, Tone Polyol 2221 (manufactured by Union Carbide Corp.). Examples of commercially available products of the above aromatic polyether polyols include Uniol DA400, DA700, DA 1000, DB400 (manufactured by Nippon Oil and Fats Co., Ltd.), and the like.

A polyester polyol which can be used as the component (C) is obtained by reacting a polyhydric alcohol and a polybasic acid. Examples of the above polyhydric alcohol include ethylene glycol, polyethylene glycol, propylene glycol, polypropylene glycol, tetramethylene glycol, polytetramethylene glycol, 1,4-butanediol, 1,5-pentane diol, 1,6-hexanediol, 1,7-heptanediol, 1,8-octanediol, neopentyl glycol, 1,4-cyclohexanediol, 1,4-cyclohexanedimethanol, 1,2-bis(hydroxyethyl)cyclohexane, 2,2-diethyl-1,3-propanediol, 3-methyl-1,5-pentanediol, 1,9-nonanediol, 2-methyl-1,8-octanediol, glycerol, trimethylolpropane, ethylene oxide adduct of trimethylolpropane, propylene oxide adduct of trimethylolpropane, ethylene oxide and propylene oxide adduct of trimethylolpropane, sorbitol, pentaerythritol, dipentaerythritol, alkylene oxide addition polyol (for example, TMP30, PNT4 Glycol, EDA P4, EDA P8 (manufactured by Nippon Nyukazai Co., Ltd.), Quadrol (manufactured by Asahi Denka Kogyo K.K.), and Tone Polyol 0200, Tone Polyol 0221, Tone Polyol 0301, Tone Polyol 0310, Tone Polyol 2201, Tone Polyol 2221 (manufactured by Union Carbide Corp.)), and the like. Examples of the above polybasic acid include phthalic acid, isophthalic acid, terephthalic acid, maleic acid, fumaric acid, adipic acid, sebacic acid, and the like. As examples of commercially available products of these polyester polyols, Kurapol P1010, Kurapol P2010, PMIPA, PKA-A, PKA-A 2, PNA-2000 (manufactured by Kuraray Co., Ltd.), and the like can be given.

As examples of polycarbonate polyol which can be used as the component (C), a polycarbonate diol shown by the following formula (2) can be given:

HO— (R⁵—OCOO)₁—R⁶—OH (2)

wherein R⁵ and R⁶ represent an alkylene group having 2-20 carbon atoms, a (poly)ethylene glycol residue, (poly)propylene glycol residue, (poly)tetramethylene glycol residue, and 1 is an integer from 1-30.

Specific examples of R⁵ and R⁶ include residues of 1,4-butanediol, 1,5-pentanediol, neopentyl glycol, 1,6-hexanediol, 1,4-cyclohexanedimethanol, 1,7-heptanediol, 1,8-octanediol, 1,9-nonanediol, ethylene glycol, diethylene glycol, triethylene glycol, tetraethylene glycol, propylene glycol, dipropylene glycol, tripropylene glycol, tetrapropylene glycol, and the like.

As the above polycarbonate polyols, commercially available products such as DN-980, DN-981, DN-982, DN-983 (manufactured by Nippon Polyurethane Industry Co., Ltd.), PC-8000 (manufactured by PPG), PNOC 1000, PNOC 2000, PMC 100, PMC 2000 (manufactured by Kuraray Co., Ltd.), and PLACCEL CD-205, CD-208, CD-210, CD-220, CD-205PL, CD-208PL, CD-210PL, CD-220PL, CD-205HL, CD-208HL, CD-210HL, CD-220HL, CD-210T, CD-221T (manufactured by Daicel Chemical Industries, Ltd.) can be used.

Examples of the above polycaprolactone polyols include polycaprolactone diols obtained by the addition of ε-caprolactone to diols such as ethylene glycol, polyethylene glycol, propylene glycol, polypropylene glycol, tetramethylene glycol, polytetramethylene glycol, 1,2-polybutylene glycol, 1,6-hexanediol, neopentyl glycol, 1,4-cyclohexanedimethanol, and 1,4-butanediol. Commercially available products such as PLACCEL 205, 205AL, 212, 212AL, 220, 220AL, (manufactured by Daicel Chemical Industries, Ltd.) can be used as the above polycaprolactone polyols.

Examples of aliphatic hydrocarbons having two or more hydroxyl groups in the molecule used as the component (C) include ethylene glycol, propylene glycol, tetramethylene glycol, 1,4-butanediol, 1,5-pentanediol, 1,6-hexanediol, 1,7-heptanediol, 1,8-octanediol, 1,9-nonanediol, neopentyl glycol, 2,2-diethyl-1,3-propanediol, 3-methyl-1,5-pentanediol, 2-methyl-1,8-octanediol, hydroxy-terminal hydrogenated polybutadiene, glycerol, trimethylolpropane, pentaerythritol, sorbitol, and the like.

Examples of alicyclic hydrocarbons having two or more hydroxyl groups in the molecule used as the component (C) include 1,4-cyclohexanediol, 4-cyclohexanedimethanol, 1,2-is(hydroxyethyl)cyclohexane, dimethylol compounds of dicyclopentadiene, tricyclodecanedimethanol, and the like.

Examples of unsaturated hydrocarbons having two or more hydroxyl groups in the molecule used as the component (C) include hydroxy-terminal polybutadiene, hydroxy-terminal polyisoprene, and the like. Examples of other polyols used as the component (C) include β-methyl-δ-valerolactonediol, castor oil-modified diol, terminal diol compounds of polydimethylsiloxane, polydimethylsiloxane carbitol-modified diol, and the like.

These polyols can be used either individually or in combinations of two or more as the component (C).

The proportion of the component (C) to be used in the photo curable resin composition of the present invention is preferably 3-50 wt %, more preferably 5-40 wt %, and particularly preferably 7-30 wt %. If the proportion of the component (C) is too small, improvement of photo-curability of the resulting resin composition is insufficient.

The photo curable adhesive composition of the present invention comprises an organotin compound (D) (hereinafter called “component (D)”) as an essential component. Although applicant does not want to be bound to the theory, it is thought that the component (D) captures ionic substances generated from a cationically polymerizable catalyst to prevent corrosion in the metal recording layer of the optical disks.

Examples of the organotin compounds which can be used as the component (D) include: dialkyltin dialiphatic acid salt such as di-n-butyltin dilaurate [(C₄H₉)₂Sn[OCO(CH₂)₁₀CH₃]₂], di-n-octyltin dilaurate [(C₈H₁₇)₂Sn[OCO(CH₂)₁₀CH₃]₂], di-n-butyltin diacetate [(C₄H₉)₂Sn(OCOCH₃)₂]; dialkyltin dialiphatic acid salt oxide such as di-n-butyltin dialiphatic acid salt oxide [[(C₄H₉)₂Sn (OCOR⁷)]₂O] (wherein R⁷ represents an alkyl group); alkyltin trialiphatic acid salt such as mono-n-butyltin trialiphatic acid salt [C₄H₉Sn(OCOR⁸)₃] (wherein R⁸ represents an alkyl group); dialkyltin bis(monomaleate) salt such as di-n-butyltin bisalkylmaleate [(C₄H₉)₂Sn(OCOCH═CHCOOR⁹)₂] (wherein R⁹ represents an alkyl group) and di-n-octyltin bisalkylmaleate [(C₈H₁₇)₂Sn (OCOCH═CHCOOR¹⁰)₂] (wherein R¹⁰ represents an alkyl group); dialkyltin bis(monothioglycolate) salt such as di-n-butyltin bis(2-ethylhexyl thioglycolate) salt [(C₄H₉)₂Sn (SCH₂COOC₈H₁₇)₂], di-n-octyltin bis (iso-octyl thioglycolate) salt [(C₈H₁₇)₂Sn(SCH₂COOC₈H₁₇)₂], and di-n-methyltin bis(iso-octyl thioglycolate) salt [(CH₃)₂Sn(SCH₂COOC₈H₁₇)₂]; and the like. Of these organotin compounds, di-n-butyltin dilaurate and di-n-butyltin bisalkylmaleate are particularly preferable.

Examples of commercially available products of the organotin compound suitable as the component (D) include KS-1260 (manufactured by Kyodo Chemical Co., Ltd.), SCAT-1, SCAT-4L, SCAT-8, SCAT-24, OBTACK, STANN ONZ-72F, STANN JF-1 0B (manufactured by Sankyo Organic Chemicals Co., Ltd.), and the like. These organotin compounds can be used either individually or in combinations of two or more as the component (D).

The proportion of the component (D) used in the photo curable resin composition of the present invention is preferably 0.01-5 wt %, more preferably 0.05-4 wt %, and particularly preferably 0.1-3 wt %. A proportion of less than 0.01 wt % may cause corrosion of metals; on the other hand, a proportion of more than 5 wt % results in insufficient adhesion.

In the photo curable resin composition of the present invention, components other than the above essential components (components (A) to (D)) can be used insofar as the photo-curability is not impaired. As examples of these optional components, photosensitizers such as thioxanethone, derivatives of thioxanethone, anthraquinone, derivatives of anthraquinone, anthracene, derivatives of anthracene, perylene, derivatives of perylene, benzophenone, and benzoin isopropyl ether can be given.

Various additives can be added to the photo curable resin composition of the present invention. Examples of such additives include polymerization inhibitors such as polymers or oligomers such as an epoxy resin, polybutadiene, polychloroprene, polyether, polyester, styrene-butadiene-styrene block copolymer, petroleum resin, xylene resin, ketone resin, cellulose resin, fluorine-containing oligomer, silicone oligomer, polysulfide oligomer, phenothiazine, and 2,6-di-t-butyl-4-methylphenol, polymerization adjuvants, leveling agents, wettability improvers, surfactants, plasticizer, UV absorbers, silane coupling agents, inorganic fillers, resin particles, pigments, dyes, and the like.

The photo curable resin composition of the present invention is prepared by homogeneously mixing the above components (A)-(D), optional components, and additives.

The viscosity (25° C.) of the photo curable resin composition thus prepared is preferably 50 mPas or higher, more preferably 70 mPas or higher and particularly preferred 100 mPas or higher. The viscosity preferably is 5,000 mPas or lower, more preferably 3,000 mPas or lower and particularly preferred 1,000 mPas or lower.

The composition of the present invention can be cured by the irradiation of ultraviolet rays, visible rays, or electron beams in the same manner as in a conventional photo curable resin composition. For example, the composition of the present invention is applied to an substrate so that the thickness of the adhesive layer is 10-100 μm, and cured by irradiation using a metal halide ramp at a dose of 10-2000 mJ/cm². Preferably, the thickness of the adhesive layer is 15-50 μm; the amount of irradiation about 50-500 mJ/cm². The other substrate is put on this layer so that they adhere together.

It is preferable that the cured products of the composition of the present invention have excellent transparency. For example, it is preferable that light transmittance of the cured products having a thickness of 60 μm be 90% or more at a wavelength of 600-700 nm. If the light transmittance is less than 90%, appearance of the optical disks is impaired and the adhesive layer weakens the light for reading the information recorded on the disk to make it difficult to read the information. Therefore, in preparing the composition of the present invention, the components should be blended so that the light transmittance of the resulting cured product satisfies this requirement.

Preferably, the components are so blended as to achieve, in a cured adhesive bonding two aluminium sputtered PC substrates in a DCD, a shear strength of about 10-50 lbs.

Since the composition of the present invention exhibits excellent adhesion to plastics such as polycarbonate (PC) and poly(methyl methacrylate) (PMMA), metals such as gold and aluminum, inorganic compounds such as glass, and the like, and does not corrode metals, the composition is suitable as an adhesive for optical disks. More in particular, with the adhesive of the present invention it is possible to make aluminium sputtered PC discs that withstand durability testing at 80° C. and 95% relative humidity for more than 24 hr, preferably more than 96 hr. Preferably, the constituents of the adhesive are chosen as to achieve a DVD which in the above described test does not show abnormalities if the aluminium layers are observed by the naked eye. More preferably when observed with a microscope at 5× magnification no abnormalities such as bubbles or corrosion can be seen. The adhesive of the present invention is in particular suitable to adhere two discs of a high density recording medium in which two discs have a semi- or non-transparent layer (for UV light). Semi-transparent means that less than 50% of the UV light is transferred through a disc; non-transparent means that less than 5% of the UV light is transferred through a disc.

The present invention will now be described in detail by way of examples, which should not be construed as limiting the present invention.

### EXAMPLES

### Example 1

(1) Preparation of Composition for Forming Photo-curable Coating Film

A reaction vessel equipped with a stirrer was charged with 60 parts by weight (hereinafter abbreviated as “part(s)”) of 3,4-epoxycyclohexylmethyl-3′,4′-epoxycyclohexanecarboxylate, 20 parts of hydrogenated bisphenol A diglycidyl ether, 2 parts of bis[4-(di(4-(2-hydroxyethyl)phenyl)sulfonio)]-phenylsulfide, 20 parts of PO-modified glycerol, and 1 part of di-n-butyltin dilaurate. The mixture was stirred to prepare a resin composition for the coating film. Moisture-heat resistance of this resin composition was evaluated as follows.

(2) Evaluation of Moisture-heat Resistance

On an aluminum substrate prepared by sputtering a PC substrate, the resin composition was applied using a spin coater so that the film thickness was about 50 μm. The resin composition was irradiated at a dose of 100 mJ/cm². An aluminum substrate prepared by sputtering on a PC substrate was applied to this substrate and the substrates were allowed to stand at 23° C. and 55% RH for one day to allow the substrate to adhere. The substrates were then allowed to stand in a thermo-hygrostat (temperature: 80° C., relative humidity: 95% RH). After standing for both 24 hours and 96 hours, in the case where abnormalities such as bubbles and corrosion was observed in the adhesive layer or an interface between the adhesive and the substrate, the moisture-heat resistance was judged as inferior, which is indicated by “X”. In the case where no abnormality was observed, the moisture-heat resistance was judged as good, which is indicated by “O”.

### Examples 2-5

According to the formulation shown in Table 1, resin compositions for coating films were prepared in the same manner as in Example 1 and the moisture-heat resistance of the resin compositions were evaluated.

As is clear from the results shown in Table 1, the resin compositions of Examples 1-5 exhibited excellent moisture-heat resistance after 96 hours.

### Comparative Examples 1-3

According to the formulations shown in Table 1, resin compositions for coating films were prepared in the same manner as in Example 1 except that the component (D) was not used. The moisture-heat resistance of the resin compositions were evaluated. As is clear from the results shown in Table 1, the resin compositions of Comparative Examples 1-3 which did not contain the component (D) exhibited inferior moisture-heat resistance after 24 hours.

TABLE 1

| | Examples | | | | Comparative Examples | | | |
|---|---|---|---|---|---|---|---|---|
| Component | 1 | 2 | 3 | 4 | 5 | 1 | 2 | 3 |
| A1 | 60 | | | 60 | | 60 | | |
| A2 | 20 | 20 | | 20 | 20 | 20 | 20 | |
| A3 | | 60 | 60 | | 60 | | 60 | 60 |
| A4 | | | 20 | | | | | 20 |
| B1 | 2 | | 2 | 2 | | 2 | | 2 |
| B2 | | 2 | | | 2 | | 2 | |
| C1 | 20 | | 20 | 20 | | 20 | | 20 |
| C2 | | 20 | | | 20 | | 20 | |
| D1 | 1 | | 1 | 0.5 | | | | |
| D2 | | 1 | | | 0.5 | | | |
| Adhesion | ◯ | ◯ | ◯ | ◯ | ◯ | ◯ | ◯ | ◯ |
| Moisture-heat resistance | ◯ | ◯ | ◯ | ◯ | ◯ | X | X | X |
| (after 24 hours) | | | | | | | | |
| Moisture-heat resistance | ◯ | ◯ | ◯ | ◯ | ◯ | X | X | X |
| (after 96 hours) | | | | | | | | |

Component (A)

A1: 3,4-epoxycyclohexylmethyl-3′,4′-epoxycyclohexanecarboxylate (trade name: KRM-2110, manufactured by Asahi Denka Kogyo Co., Ltd.)

A2: hydrogenated bisphenol A diglycidyl ether (trade name: Epolite 4000, manufactured by Kyoeisha Chemical Co., Ltd.)

A3: bis-(3,4-epoxycyclohexyl)adipate (trade name: UVR-6128, manufactured by Union Carbide Corp.)

A4: neopentyl glycol diglycidyl ether (trade name: Epolite 1500NP, manufactured by Kyoeisha Chemical Co., Ltd.)

Component (B)

B1: bis[4-(di(4-(2-hydroxyethyl)phenyl)sulfonio)]-phenyl sulfide (trade name: Adekaoptomer SP-170, manufactured by Asahi Denka Kogyo Co., Ltd.)

B2: triallylsulfonium hexafluoroantimonate salt (trade name: UVI-6974, manufactured by Union Carbide Corp.)

Component (C)

C1: PO-modified glycerol (trade name: Sunnix GP-250, manufactured by Sanyo Chemical Industries, Ltd.)

C2: ε-caprolactonetriol (trade name: TONE-0301, manufactured by Union Carbide Corp.)

Component (D)

D1: di-n-butyltin dilaurate (trade name: KS-1260, manufactured by Kyodo Chemical Co., Ltd.)

D2: di-n-butyltin bisalkylmaleate (trade name: OBTACK, manufactured by Sankyo Organic Chemicals Co., Ltd.)

1. A photo curable resin composition comprising (A) a cationically polymerizable organic compound, (B) a cationic photopolymerization initiator, (C) a polyol having two or more hydroxyl groups in the molecule, and (D) an organotin compound.

2. The composition according to claim 1, wherein the cationically polymerizable organic compound (A) is one or more compounds selected from the group consisting of a cyclic ether compound, cyclic thioether compound, cyclic acetal compound, cyclic lactone compound, vinyl ether compound, spiroorthoester compound, and ethylenically unsaturated compound.

3. The composition according to claim 1 or 2, wherein the organotin compound (D) is one or more compounds selected from the group consisting of a dialkyltin dialiphatic acid salt, dialkyltin dialiphatic acid salt oxide, alkyltin trialiphatic acid salt, dialkyltin bis(monomaleate) salt, and dialkyltin bis(monothioglycolate) salt.

4. The composition according to any one of claims 1-3, wherein the composition comprises 30-96 wt. % of component A, 0.1-20 wt. % of component B, 3-50 wt. % of component C and 0.01-5 wt. % of component D.

5. The composition according to any one of claims 1-4, wherein the composition has a viscosity of about 50-30,000 mPas at 25° C.

6. The composition according to any one of claims 1-5, wherein component (A) is constituted of at least 50 wt. % of 2 or more functional compounds.

7. High density recording medium comprising at least two discs, the two discs being adhered to each other by a cured composition according to any one of claims 1-6.

8. The recording medium of claim 7, wherein two discs have a semi or non-transparent layer for UV-light.

9. The recording medium according to any one of claims 7-8 wherein the cured adhesive has a light transmittance through a 60 μm thick layer of 90% or more at a wave length of 600-700 nm.

10. The recording medium according to any one of claims 7-9 wherein the adhesive does not cause abnormalities to an aluminium sputtered polycarbonate disc after a durability test at 80° C. at 95% RH for more than 24 hr, preferably more than 96 hr.
